(19) United States
(12) Patent Application Publication
(10) Pub. No.: US 2004/0131376 A1
(43) Pub. Date: Jul. 8, 2004

(54) Input processing system and image processing apparatus

(75) Inventors: Hideyuki Hashimoto, Toyokawa-shi (JP); Mie Kawabata, Toyokawa-shi (JP); Toshihisa Motosugi, Okazaki-shi (JP)

Correspondence Address: MORRISON & FOERSTER LLP, 1650 TYSONS BOULEVARD, SUITE 300, MCLEAN, VA, 22102, US

(73) Assignee: Minolta Company, Ltd., Osaka-shi (JP)

(21) Appl. No.: 10/662,938

(22) Filed: Sep. 16, 2003

(30) Foreign Application Priority Data
Sep. 17, 2002 (JP) 2002-270233

(51) Int. Cl. G03G 21/14

(52) U.S. Cl. 399/76

(57) ABSTRACT

An input processing system including a plurality of input apparatuses, a processing apparatus, a setter that sets an operation of the processing apparatus in accordance with an input entered through an input operation performed on an input apparatus, and a controller that determines an automatic-clear time for the input apparatus. A different automatic-clear time is determined for each of the plurality of input apparatuses. If another input operation is not performed on the input apparatus during the determined automatic-clear time, the controller executes an automatic-clear function to clear the set operation to an initially set default.

This application is based on application No. 2002-270233 filed in Japan, the contents of which are hereby incorporated by reference.

### BACKGROUND OF THE INVENTION

(1) Field of the Invention

The present invention relates to an input processing system and an image processing apparatus.

(2) Description of the Related Art

Image processing apparatuses such as copying machines are often shared by a lot of users. The users who share an image processing apparatus may include the disabled such as those whose mobility at upper limbs is impaired. There is a demand therefore that the image processing apparatuses should be able to be used easily even by the disabled, as well as by the able-bodied. To satisfy such a demand, the image processing apparatuses may be provided with, in addition to a keyboard that is a typical operation unit mainly designed for the able-bodied, an operation unit achieved by a joystick, a mouse or the like that are thought to be used relatively easily by the disabled.

Meanwhile, many image processing apparatuses have what is called an automatic-clear function. The automatic-clear function clears the settings that have been specified by the user so far (the number of sheets to be copied, copying density, copying mode and the like) to the initial settings when no input operation is performed during a predetermined time period, where the initial settings are standard settings that are expected to be specified by users at the highest rate, in which the number of sheets to be copied is set to “1”, the copying density “normal”, and copying mode “single-side copying mode”, for example.

The automatic-clear function is provided to prevent such a case where after a user uses a copying machine and fails to clear the settings he/she specified, the next user uses the copying machine with the settings specified by the preceding user. Typically, the “predetermined time period” mentioned above (hereinafter referred to as an automatic-clear time) used in the automatic-clear function is set to 60 seconds.

The automatic-clear function (also referred to as “auto-reset function”) is disclosed in U.S. Pat. No. 6,338,759 and Japanese Laid-Open Patent Application No. 55-50256.

The automatic-clear function, however, may become a problem for those who have not leaned how to use image processing apparatuses well. That is to say, for some users who are not accustomed to the operation unit such as the joystick or mouse, it is expected to take time to operate the operation unit, and the automatic-clear function may be activated before the user inputs a specification. When this happens, the settings that have been specified by the user so far are cleared to the initial settings, and the user must specify the settings from the start again.

To solve this problem, the automatic-clear time may be set to a longer time. With this arrangement, however, the settings specified by the previous user remain for a longer time. This is against the original purpose of the automatic-clear function.

The problem may also occur in an input processing system in which the number of sheets to be copied, copying mode or the like can be specified from a terminal apparatus that is connected to an image processing apparatus and shared by a plurality of users who input their specifications using input apparatuses connected to the terminal apparatus.

### SUMMARY OF THE INVENTION

The object of the present invention is therefore to provide an image processing apparatus and an input processing system that facilitate the user operations by preventing the settings having been specified by the user so far from being cleared in the middle of an input operation due to activation of the automatic-clear function.

The above object is fulfilled by an input processing system comprising: a plurality of input apparatuses; a processing apparatus; a setter that sets an operation of the processing apparatus in accordance with an input entered through an input operation performed on an input apparatus among the plurality of input apparatuses; and a controller that determines an automatic-clear time for the input apparatus on which the input operation was performed, wherein a different automatic-clear time is determined for each of the plurality of input apparatuses, and if another input operation is not performed on the input apparatus during the determined automatic-clear time, executes an automatic-clear function to clear the set operation to an initially set default.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a block diagram showing the construction of a digital process copying machine in Embodiment 1;

FIG. 2 shows a construction example of the setting table;

FIG. 3 shows an example of the automatic-clear time table;

FIG. 4 is a flowchart of the input signal reception process executed by a CPU;

FIG. 5 is a flowchart of a subroutine for the automatic-clear time determination process;

FIG. 6 is a block diagram showing the construction of an input processing system in Embodiment 2;

FIG. 7 is a flowchart of an input signal reception/transmission process executed by a PC main body of a terminal apparatus;

FIG. 8 is a flowchart of the input signal reception process executed by a CPU of a copying machine;

FIG. 9 is a block diagram showing the construction of an input processing system in Embodiment 3;

FIG. 10 is a flowchart of an input signal reception/transmission process executed by a PC main body of a terminal apparatus;

FIG. 11 is a flowchart of a process executed by a CPU of a server;

FIG. 12 is a flowchart of the input signal reception process executed by a CPU of a copying machine; and

FIG. 13 shows an example of an automatic-clear time table used in a modification of the present invention.

### DESCRIPTION OF THE PREFERRED EMBODIMENT

The following describes preferred embodiments of the present invention with reference to the attached drawings.

Embodiment 1

1.1 Overall Construction

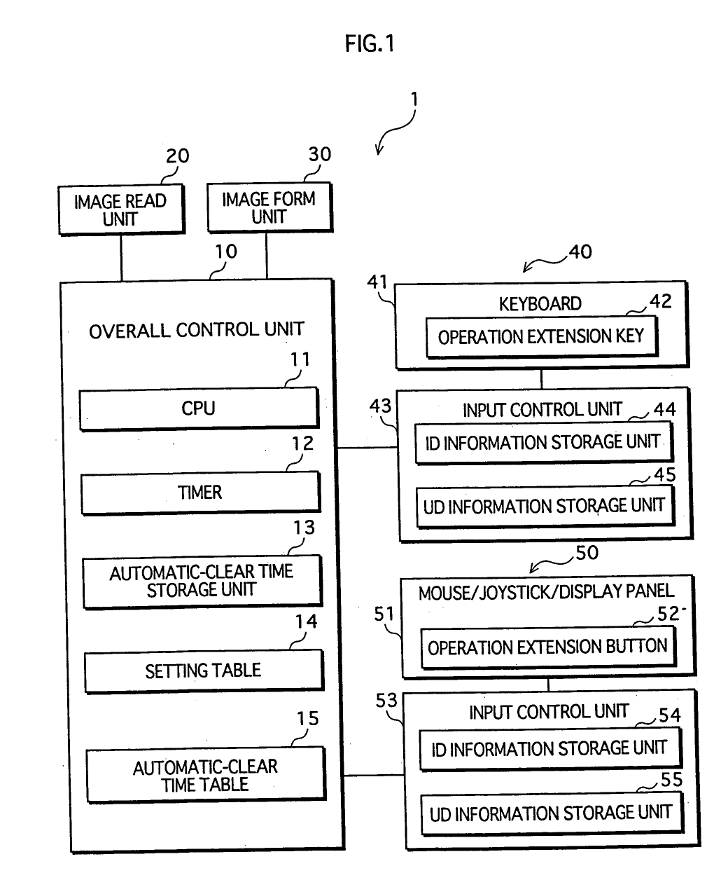

FIG. 1 is a block diagram showing the construction of a digital process copying machine 1 (hereinafter referred to as copying machine 1) in Embodiment 1.

As shown in FIG. 1, the copying machine 1 includes an overall control unit 10, an image read unit 20, an image form unit 30, and input units 40 and 50.

The image read unit 20 reads image data from an original document set on the copying machine by scanning the original document. The image form unit 30 forms images on recording sheets based on the image data read by the image read unit 20, using a known electrophotography technique. It is supposed here that the copying machine 1 provides a single-side copying function and a double-side copying function. With the single-side copying, images are formed on one side of the sheets, and with the double-side copying, images are formed on both sides of the sheets.

The input unit 40 includes: an operation unit 41 achieved by a keyboard; and an input control unit 43.

The operation unit 41 includes various kinds of keys (not illustrated) used by the users to enter inputs, such as: a start key used for starting a copy; a numeric keypad used for setting the number of sheets to be copied, density, double-side copying mode and other copy-related functions; a density adjustment key; and keys used for setting the double-side copying mode. The operation unit 41 is mainly designed for the able-bodied. The operation unit 41 includes an operation extension key 42 that is used to extend the automatic-clear time. In Embodiment 1, the automatic-clear time is extended by five minutes each time the operation extension key 42 is operated. The operation extension key 42 can be used either before or while an input operation is performed.

The input control unit 43 detects a depression of any key in the operation unit 41 by the user, and transmits an input signal corresponding to the depressed key to the overall control unit 10 each time a key is depressed. For example, if the user depresses a key “5” in the numeric keypad to specify the number of sheets to be copied, the input control unit 43 transmits an input signal indicating that the key “5” was depressed to specify the number of sheets to be copied, to the overall control unit 10. Also, if the user depresses the operation extension key 42, the input control unit 43 transmits an input signal indicating that the operation extension key 42 was depressed, to the overall control unit 10. The overall control unit 10 receives input signals and stores the contents of the received input signals into a setting table 14 provided therein.

The input control unit 43, each time it transmits an input signal, reads from an ID (identification) information storage unit 44 the ID information that identifies the input unit 40, and transmits the read ID information to the overall control unit 10. The ID information is stored in advance in the ID information storage unit 44, and includes data (a character sequence, a numeral or the like) that indicates that the operation unit 41 is a keyboard.

Also, the input control unit 43 reads from a UD information storage unit 45 the UD information that indicates whether the input unit 40 is universal-design-compliant or not, and incorporates the read UD information into the ID information to be transmitted. It should be noted here that “universal-design-compliant” means that the input unit 40 is designed for both types of users who are accustomed and unaccustomed to the input operations, in terms of the key arrangement, size, color or the like. The UD information is stored in advance in the UD information storage unit 45. In the case where the input unit 40 is universal-design-compliant, it is expected that people who are not accustomed to the input operations may use the copying machine 1, and therefore, the automatic clear time is set to a time period that is 30 seconds longer than a time period for the case where the input unit 40 is not universal-design-compliant, allowing the users who are unaccustomed to the input operations leeway. This will be detailed later.

On the other hand, the input unit 50 includes: an operation unit 51 composed of a mouse, a joystick, a large display panel or the like; and an input control unit 53.

The operation unit 51 is designed mainly for the disabled, with some contrivance for facilitating the disabled. More specifically, a setting screen is displayed on the display panel for the user to set the number of sheets to be copied, density, copying mode and other copy-related functions. The user can set the number of sheets to be copied or the like using the joystick and the mouse to move the cursor on the setting screen to an area for desired items. For example, when the user wants to set the number of sheets to “10”, the user moves the cursor to areas for “1” and “0” in sequence to click on the areas. Also, the user can specify the double-side copying by moving the cursor onto a check box for the double-side copying mode and clicking on it, as checking.

The setting screen displayed on the display panel includes a start button. The user can start a copy by clicking on the start button. Furthermore, the setting screen includes an operation extension button 52. The user can extend the automatic-clear time by five minutes, as is the case with the input unit 40, by clicking on the operation extension button 52. It should be noted here that the operation extension button 52 maybe provided outside the display area, as a depression-type button.

The input control unit 53 detects each input entered by the user using the joystick or the like, and controls the display on the display panel. Also, as is the case with the input control unit 43, the input control unit 53 transmits an input signal corresponding to an input (click) to the overall control unit 10 each time the user enters an input. In Embodiment 1, when the cursor is moved by an operation of the joystick or mouse, the input control unit 53 regards the movement as an input operation and transmits an input signal indicating that the cursor moved. Receiving the input signal from the input control unit 53, the overall control unit 10 recognizes that the user is in the middle of the input operation and that the operation has not yet completed.

The input control unit 53, each time it transmits an input signal, reads from an ID information storage unit 54 the ID information that identifies the input unit 50, and transmits the read ID information to the overall control unit 10. The ID information is stored in advance in the ID information storage unit 54, and includes data indicating that the operation unit 51 is composed of a joystick, a mouse or the like.

Also, the input control unit 53 reads from a UD information storage unit 55 the UD information that indicates whether the input unit 50 is universal-design-compliant or not, and incorporates the read UD information into the ID information to be transmitted. The UD information is stored in advance in the UD information storage unit 55. When the input unit 50 is universal-design-compliant, the automatic clear time is set to a time period that is 40 seconds longer than a time period for the case where the input unit 50 is not universal-design-compliant.

The overall control unit 10 includes a CPU 11, a timer 12, an automatic-clear time storage unit 13, a setting table 14, and an automatic-clear time table 15.

The CPU 11 controls the image read unit 20 and the image form unit 30 to execute the copy operation smoothly. Also, the CPU 11 receives input signals from the input units 40 and 50. Also, the CPU 11 executes an input signal reception process in which the automatic-clear time is changed in accordance with which of the input units 40 and 50 has transmitted an input signal (the input signal reception process will be described in detail later).

The timer 12 is used to measure a “no-input-operation time” in automatic-clear time determination process (which will be described later) that is executed in the input signal reception process.

The automatic-clear time storage unit 13 is achieved by a volatile memory such as a RAM, and stores data representing the automatic-clear time that is determined in the automatic-clear time determination process.

The setting table 14 is a table for storing the settings specified by the user concerning a copy operation.

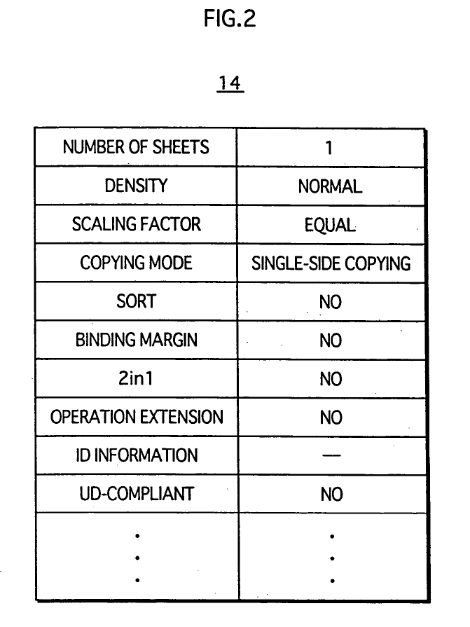

FIG. 2 shows a construction example of the setting table 14. Each time it receives an input signal, the CPU 11 writes data contained in the received input signal onto a corresponding column in the setting table 14. For example, if a received input signal contains data indicating “5” as the number of sheets to be copied, the CPU 11 rewrites “5” onto the “number of sheets” column in the table. Also, if a received input signal contains data indicating specification of double-side copying mode, the CPU 11 rewrites “double-side copying” onto the “copying mode” column in the table. The settings of the setting table shown in FIG. 2 are default settings (initial settings) that are presumed to be specified by users at the highest rate. The CPU 14 executes a copy operation based on the settings in the setting table 14. In the example shown in FIG. 2, the number of sheets to be copied is set to “1”, the copying density “normal”, scaling factor “equal”, copying mode “single-side copying mode”, . . . .

The setting table 14 also includes a column for storing the ID information. The ID information indicates “keyboard” if it is transmitted from the input unit 40, and indicates “joystick or the like” if it is transmitted from the input unit 50. The setting table 14 also includes a column for storing the UD information. Data indicating whether the input unit is universal-design-compliant or not is stored in the UD-compliant column.

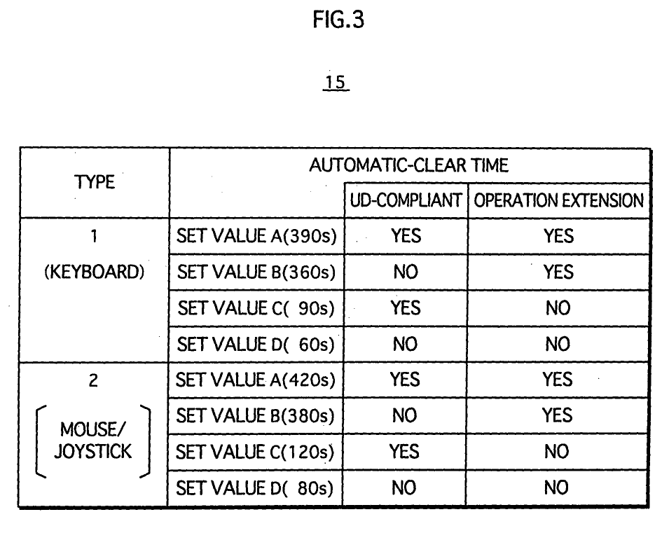

Back to the explanation of the construction shown in FIG. 1, the automatic-clear time table 15 is a table referred to in the automatic-clear time determination process, to determine the automatic-clear time. FIG. 3 shows an example of the automatic-clear time table 15. As shown in FIG. 3, the automatic-clear time table 15 includes a “type” column and an “automatic-clear time” column.

The “type” column shows types of input units. In the present embodiment, the “type” column shows two types “1” (keyboard) and “2” (mouse/joystick) that correspond to the input units 40 and 50, respectively.

The “automatic-clear time” column shows, for each type shown in the “type” column, four set values that respectively correspond to all combinations of (i) whether the input unit is universal-design-compliant or not and (ii) whether an operation extension has been specified or not.

In the present example: the set value A corresponds to the case where the input unit is universal-design-compliant and an operation extension has been specified; the set value B corresponds to the case where the input unit is not universal-design-compliant and an operation extension has been specified; the set value C corresponds to the case where the input unit is universal-design-compliant and an operation extension has not been specified; and the set value D corresponds to the case where the input unit is not universal-design-compliant and an operation extension has not been specified.

For example, when the input unit 40 (type “1”) that is not universal-design-compliant is operated by the user and an operation extension has not been specified, the automatic-clear time is set to 60 seconds, the set value D. Also, when the input unit 50 (type “2”) that is not universal-design-compliant is operated by the user and an operation extension has not been specified, the automatic-clear time is set to 80 seconds, the set value D. The reason why the set value D for the input unit 50 is 20 seconds longer than the set value D for the input unit 40 is that an input operation by the disabled is expected to be longer than an input operation by the able-bodied, and the automatic-clear time for the disabled is set to be longer by just that much to prevent values set by the user from being cleared by the automatic-clear function in the middle of the setting.

Also, as shown in FIG. 3, when an operation extension has been specified, the automatic-clear time is increased by five minutes (300 seconds), compared with the case where an operation extension has not been specified. Also, when the input units 40 and 50 that are universal-design-compliant are operated, the automatic-clear time is increased byb 30 seconds and 40 seconds, respectively, compared with the case where the input units that are not universal-design-compliant are operated. When an operation extension has been specified, and an input unit that is universal-design-compliant is operated, the automatic-clear time is increased as much, that is, increased by the total of the increases.

1.2 Input Signal Reception Process

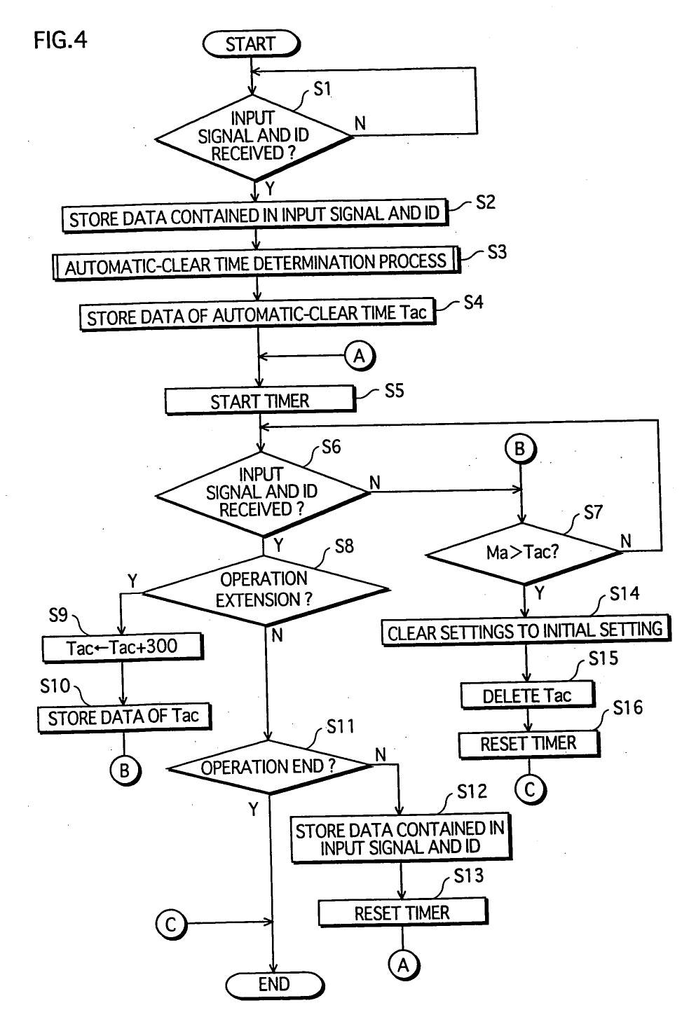

FIG. 4 is a flowchart of the input signal reception process executed by the CPU 11.

As shown in FIG. 4, the CPU 11 judges whether an input signal and ID information (hereinafter referred to as an input signal and ID) have been received (step S1).

If the CPU 11 judges positively in step S1 (“Y”), the CPU 11 rewrites the data contained in the input signal and ID (for example, data indicating depression of the key “5” of the numeric keypad, ID information, and UD information contained in the ID information) into the corresponding columns in the setting table 14 (that is to say, the settings of an operation such as copying are stored in the table as specified by the user through the input operation) (step S2). It should be noted here that when the CPU 11 receives an input signal from the input unit 50 indicating a cursor movement, the CPU 11 does not write the data contained in the input signal onto the setting table 14.

The CPU 11 then executes the automatic-clear time determination process (step S3).

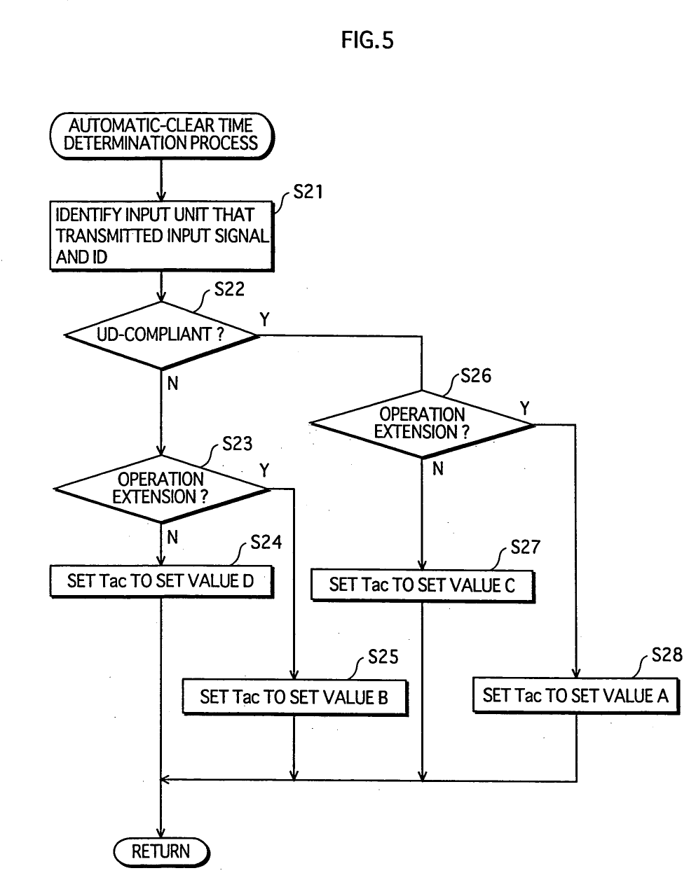

FIG. 5 is a flowchart of a subroutine for the automatic-clear time determination process.

As shown in FIG. 5, the CPU 11 refers to the ID information column in the setting table 14 and identifies the input unit (which is either the input unit 40 or 50) that has transmitted the input signal (step S21). More specifically, if the ID information stored in the setting table indicates that the operation unit is a keyboard, the CPU 11 determines the input unit to be type “1” (input unit 40), and if the ID information stored in the setting table indicates that the operation unit is a joystick/mouse, the CPU 11 determines the input unit to be type “2” (input unit 50).

The CPU 11 also refers to the UD-compliant column in the setting table 14 and determines whether the input unit is universal-design-compliant or not (step S22).

When a judgment result of step S22 is negative (“N”), the CPU 11 refers to the operation extension column in the setting table 14 and judges whether an operation extension has been specified (step S23).

When a judgment result of step S23 is negative (“N”), the CPU 11 refers to the automatic-clear time table 15 and determines the set value D corresponding to the determined conditions for the input unit as an automatic-clear time “Tac” (step S24), then returns to themain routine. Here, for example, if the CPU 11 has received an input signal from the input unit 40, the automatic-clear time “Tac” is set to 60 seconds, and if the CPU 11 has received an input signal from the input unit 50, the automatic-clear time “Tac” is set to 80 seconds.

When a judgment result of step S23 is positive (“Y”), the CPU 11 refers to the automatic-clear time table 15 and determines the set value B corresponding to the determined conditions for the input unit as the automatic-clear time “Tac” (step S25), then returns to the main routine. Here, for example, if the CPU 11 has received an input signal from the input unit 40, the automatic-clear time “Tac” is set to 360 seconds, and if the CPU 11 has received an input signal from the input unit 50, the automatic-clear time “Tac” is set to 380 seconds.

When a judgment result of step S22 is positive (“Y”), the CPU 11 refers to the operation extension column in the setting table 14 and judges whether an operation extension has been specified (step S26).

When a judgment result of step S26 is negative (“N”), the CPU 11 refers to the automatic-clear time table 15 and determines the set value C corresponding to the determined conditions for the input unit as the automatic-clear time “Tac” (step S27), then returns to the main routine. Here, for example, if the CPU 11 has received an input signal from the input unit 40, the automatic-clear time “Tac” is set to 90 seconds, and if the CPU 11 has received an input signal from the input unit 50, the automatic-clear time “Tac” is set to 120 seconds.

When a judgment result of step S26 is positive (“Y”), the CPU 11 refers to the automatic-clear time table 15 and determines the set value A corresponding to the determined conditions for the input unit as the automatic-clear time “Tac” (step S28), then returns to the main routine. Here, for example, if the CPU 11 has received an input signal from the input unit 40, the automatic-clear time “Tac” is set to 390 seconds, and if the CPU 11 has received an input signal from the input unit 50, the automatic-clear time “Tac” is set to 420 seconds.

Back to the flowchart of the main routine shown in FIG. 4, the CPU 11 stores the data of the automatic-clear time “Tac” determined in the automatic-clear time determination process into the automatic-clear time storage unit 13 (step S4).

The CPU 11 then causes a timer to start clocking. (step S5), and judges whether another input signal and ID have been received (step S6).

If the CPU 11 judges negatively in step S6 (“N”), the CPU 11 judges whether “Ma” is larger than the automatic-clear time “Tac” (Ma>Tac), where “Ma” represents a time value counted by the timer at the point (step S7). It should be noted here that the automatic-clear time “Tac” used in the comparison is read from the automatic-clear time storage unit 13.

If the CPU 11 judges negatively in step S7 (“N”), that is, judges that a condition “Ma”≦“Tac” is satisfied, the CPU 11 returns to step S6.

The CPU 11 then repeats steps S6 and S7 until it judges that “Ma” is larger than the automatic-clear time “Tac” (Ma>Tac). That is to say, the CPU 11 waits for another input signal and ID to be received. During this repetition, if the CPU 11 recognizes that another input signal and ID have been received, the control moves to step S8.

In step S8, the CPU 11 judges whether the newly received input signal indicates specification of an operation extension. If the CPU 11 judges positively in step S8 (“Y”), the CPU 11 adds 300 seconds to the automatic-clear time “Tac” and determines the result as the automatic-clear time “Tac” (step S9), rewrites the newly determined value of the automatic-clear time “Tac” onto the automatic-clear time storage unit 13 (step S1), and returns to step S7. This indicates that if an operation extension is specified in the middle of an input operation, even if the automatic-clear time “Tac” has been determined to be 60 seconds in the automatic-clear time determination process, the automatic-clear time “Tac” is changed to 360 seconds, namely increased by five minutes.

If the judgment result of step S8 is negative (“N”), the control moves to step S11 in which the CPU 11 judges whether the input signal judged as having been input instep S8 indicates a completion of the input operation (step S11). It is presumed here that if the input signal contains data indicating a depression of the start key (button), the CPU 11 judges that the input signal indicates a completion of the input operation.

If the CPU 11 judges negatively in step S11 (“N”), that is, a key or button other than the start key has been depressed, the CPU 11 rewrites the data contained in the input signal and ID into the corresponding columns in the setting table 14 (that is to say, the settings of an operation such as copying are stored in the table as specified by the user through the input operation) (step S12), resets the timer (step S13), and returns to step 5.

Then the CPU 11 causes the timer to start clocking (step S5), and judges whether another input signal and ID have been received (step S6). If an input signal is newly received (another input operation is performed) before the time “Ma” (non-input-operation time) reaches the automatic-clear time “Tac”, the CPU 11 resets the timer, re-starts the time M, and waits for another input operation to be performed.

If the CPU 11 judges that an operation extension has been specified in step S23 (“Y”) and determines the set value B (360 seconds) as the automatic-clear time “Tac” in step S25 in the automatic-clear time determination process (step S3) in the first round of the process, and then judges that another operation extension has been specified in step S8 (“Y”), the CPU 11 further adds 300 seconds to the automatic-clear time “Tac” in the following step S9. The automatic-clear time “Tac” at this point is 660 seconds, an increase of 10 minutes. That is to say, the automatic-clear time “Tac” is increased by five minutes each time the operation extension key (button) is depressed during an input operation by the user.

The input signal reception process is terminated when the CPU 11 judges in step S11 that the input signal indicates a completion of the input operation. Since this means that the operator has depressed the start key (button) for the machine to start a copy operation, the CPU 11 reads data from corresponding columns in the setting table 14, and starts the copy operation based on the read data.

If the CPU 11 judges that the non-input-operation time has exceeded the automatic-clear time “Tac” (Ma>Tac) in step S7 (“Y”), the control moves to step S14 in which the CPU 11 activates the automatic clear function. More specifically, in step S14, the CPU 11 clears the setting table 14 (all the settings of operations specified so far by the user) to the initial settings. The CPU 11 then deletes data from the automatic-clear time storage unit 13 (step S15), resets the timer (step S16), and ends the input signal reception process.

As described above, the copying machine in the present embodiment is provided with the input units 40 and 50 that are operated by different methods, and changes the automatic-clear time in accordance with which of the input units 40 and 50 has transmitted an input signal thereto. More specifically, when an input operation is performed on the operation unit 41 that is a keyboard mainly designed for the able-bodied, the automatic-clear time is set to a value of a conventional level; and when an input operation is performed on the operation unit 51 that is a joystick or the like mainly designed for the disabled, the automatic-clear time is set to a value longer than the conventional level since it is expected that the user of the operation unit 51 uses more time than the user of the operation unit 41. With such an arrangement, the automatic-clear time is set appropriately for both the disabled and the able-bodied. This arrangement is especially convenient for the disabled since it prevents the settings having been specified by the user so far from being cleared in the middle of an input operation due to activation of the automatic-clear function, thus enabling the user to perform the input operation at his/her own pace.

Also, the automatic-clear time is set to a longer time when an input signal is received from an input unit that includes a universal-design-compliant operation unit than when received from an input unit that includes an operation unit not being universal-design-compliant. This allows the users of the universal-design-compliant operation unit leeway even if they are unaccustomed to the input operation. Furthermore, the users can extend the automatic-clear time by five minutes. With this arrangement, if, for example, the user becomes uncertain about how to specify the settings of the copying mode, the user can refer to a manual after extending the automatic-clear time.

Embodiment 2

Embodiment 1 discloses a copying machine has two input units, while Embodiment 2 discloses an input processing system including a copying machine and a terminal apparatus that are connected to each other via a network. The copying machine receives specifications for the number of sheets, copying mode or the like from users by a remote operation, where the users input the specifications through input apparatuses connected to the terminal apparatus that respectively correspond to the users. In the following description of Embodiment 2, components that have already been explained in Embodiment 1 will not be explained, and mainly differences from Embodiment 1 will be explained. The components having the same reference numbers are expected to operate similarly as in Embodiment 1.

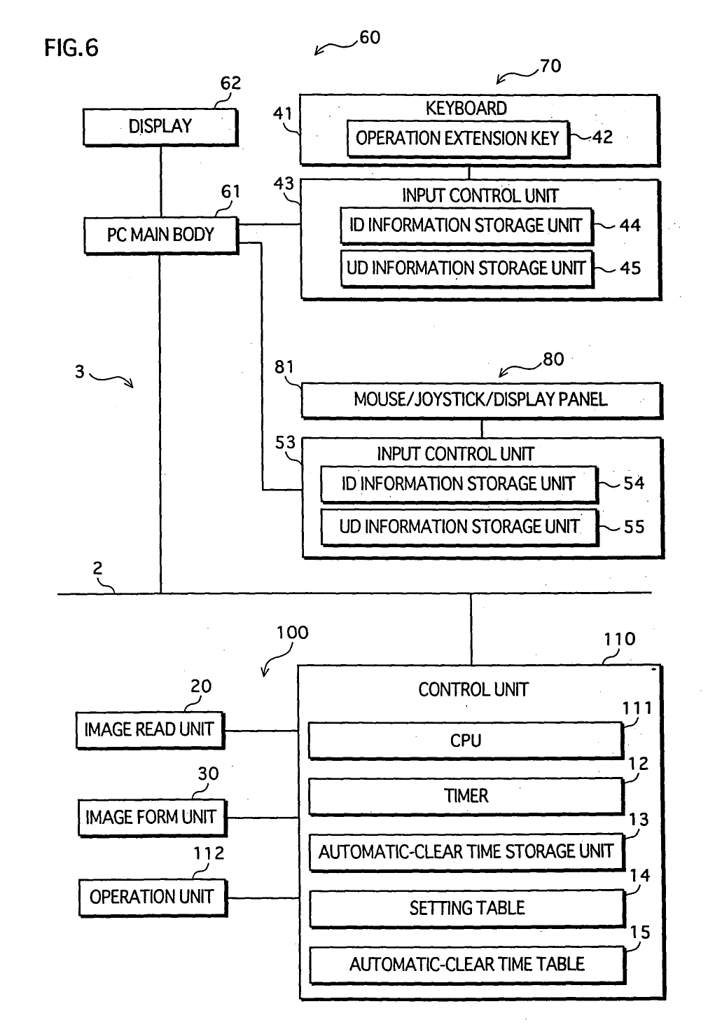

FIG. 6 is a block diagram showing the construction of an input processing system 3 in Embodiment 2.

As shown in FIG. 6, the input processing system 3 includes a terminal apparatus 60 and a copying machine 100 that are connected to each other via a network, where the network is a LAN (Local Area Network) 2 in Embodiment 2.

The terminal apparatus 60 includes a PC (Personal Computer) main body 61, a display 62, and input apparatuses 70 and 80, where the display 62 and input apparatuses 70 and 80 are connected to the PC main body 61. The input apparatuses 70 and 80 have constructions similar to those of input apparatuses 40 and 50, respectively. That is to say, the input apparatus 70 includes the operation unit 41 and the input control unit 43 that are mainly designed for the able-bodied. On the other hand, the input unit 80 includes: an operation unit 81 composed of a mouse, a joystick or the like; and the input control unit 53 that are mainly designed for the disabled. The user can enter an input to start a remote operation through any of the input apparatuses 70 and 80. The input apparatus that has received such an input from the user transmits an instruction to start the remote operation to the PC main body 61.

On receiving the instruction to start the remote operation, the PC main body 61 sends a signal (remote operation start signal) to the copying machine 100, and puts the PC main body 61 itself and the copying machine 100 into a remote operation mode (a mode in which a specification of the number of sheets to be copied or the like is received from an external apparatus). The PC main body 61 causes the display 62 to display an input screen (not illustrated) for the remote operation. The user can input a specification of the number of sheets to be copied or the like using the input apparatus 70 or 80, seeing the input screen displayed on the display 62.

As is the case with the input apparatuses 40 and 50 in Embodiment 1, each time the input apparatus 70 or 80 receives an input from the user, the input apparatus transmits an input signal indicating the contents of the input and the ID information containing the UD information to the PC main body 61. The PC main body 61 transmits the received input signal and ID to the copying machine 100. When the user inputs specification of an operation extension using the input apparatus 80, the user operates an operation extension button displayed on the input screen.

The copying machine 100 includes the image read unit 20, the image form unit 30, an operation unit 112, and a control unit 110.

The operation unit 112 is achieved by a keyboard, and is mainly designed for the able-bodied.

The control unit 110 includes a CPU 111, the timer 12, the automatic-clear time storage unit 13, the setting table 14, and the automatic-clear time table 15.

The CPU 111 goes into the remote operation mode when it receives a remote operation start signal from the terminal apparatus 60. In the remote operation mode, the CPU 111 gives a higher priority to inputs from the external terminal apparatus than inputs from the operation unit 112. Also, the CPU 111 executes an input signal reception process each time it receives an input signal and ID in the remote operation mode. The input signal reception process for setting details of operations will be described later.

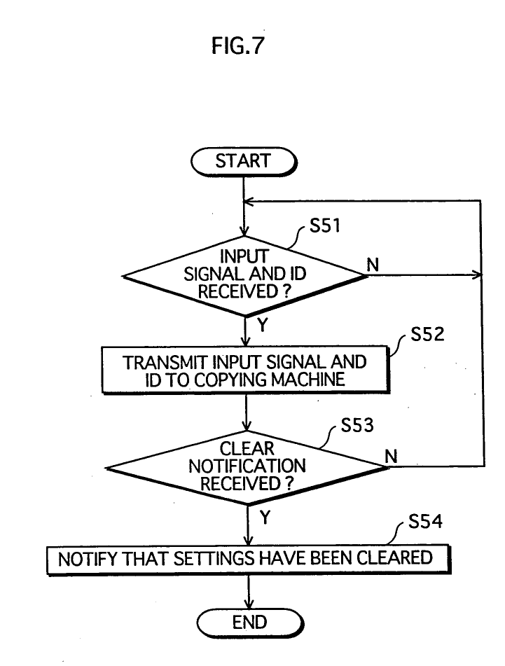

FIG. 7 is a flowchart of an input signal reception/transmission process executed by the PC main body 61 of the terminal apparatus 60. The input signal reception/transmission process is executed only in the remoter operation mode.

As shown in FIG. 7, when receiving an input signal and ID from either the input apparatus 70 or 80 (“Y” in step S51), the PC main body 61 transmits the input signal and ID to the copying machine 100 via the LAN 2 (step S52). The PC main body 61 then judges whether a clear notification has been received from the copying machine 100 (step S53). It should be noted here that the clear notification notifies that the automatic clear function has been executed and the settings have been cleared. The clear notification will be described in detail later.

If the PC main body 61 judges negatively in step S53 (“N”), the PC main body 61 returns to step. S51 and waits for another input signal.

On the other hand, if the PC main body 61 judges positively in step S53 (“Y”), the PC main body 61 notifies the user of the fact that the settings have been cleared, by displaying a message on the display 62 or outputting a voice/sound indicating the fact, for example (step S54), and ends the process. It should be noted here that since the PC main body 61 ends the remote operation mode if it receives the clear notification, the user needs to enter an instruction again to place the system in the remote operation mode if the user desires to continue the remote operation mode.

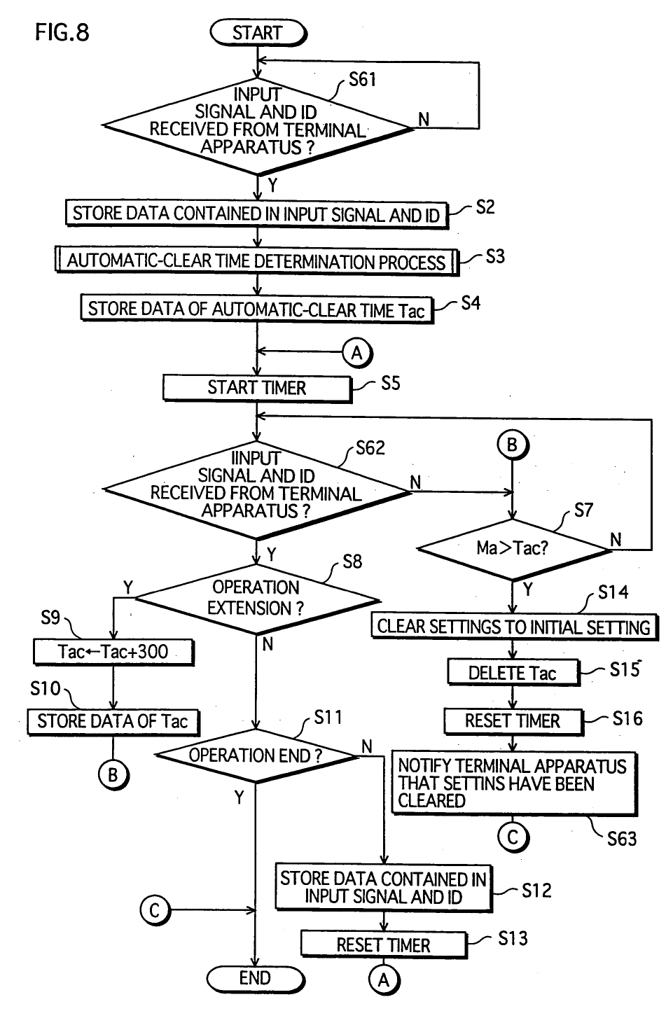

FIG. 8 is a flowchart of the input signal reception process executed by the CPU 111 of the copying machine 100. The input signal reception process is executed only in the remote operation mode. The process is almost the same as the one in Embodiment 1 (FIG. 4) except for steps S61, S62, and S63.

Steps S61 and S62 correspond to steps S1 and S6, respectively. In steps S61 and S62, it is judged whether an input signal and ID have been received from an external terminal apparatus. As is the case with Embodiment 1, the CPU 111 refers to the received input signal and ID and identifies the input apparatus, determines whether the input apparatus is universal-design-compliant, determines the automatic clear time based on the determined matters and on whether an operation extension has been specified (step S3), and stores the contents of input signals and IDs each time it receives an input signal and ID (steps S62, S7-S13). Also, if any input signal has not been received after the automatic clear time has been reached, the CPU 111 activates the automatic clear function and clears the settings (step S14).

After activating the automatic clear function, the CPU 111 notifies the terminal apparatus of the fact that the settings have been cleared (step S63). As described earlier, upon receiving the clear notification, the terminal apparatus notifies the user of the fact that the settings have been cleared, by displaying a message on the display 62 or outputting a voice/sound indicating the fact, for example (step S54).

As described above, in the present embodiment, the copying machine is operated by a remote operation by the users who enter inputs into external terminal apparatuses, and the copying machine changes the automatic-clear time based on: (a) which one of a plurality of input units in the terminal apparatus has transmitted an input signal, (b) whether the input unit is universal-design-compliant, and (c) whether an operation extension has been specified. This provides the same effect as Embodiment 1 that the automatic-clear time is set appropriately for both the disabled and the able-bodied.

Embodiment 3

In Embodiment 2, the copying machine receives input signals from terminal apparatuses via a LAN, and a copying mode or the like is set in accordance with the received input signals. In Embodiment 3, the copying machine receives input signals from terminal apparatuses via a server. In the following description, components that have already been explained in the previous embodiments will not be explained, and mainly differences from the previous embodiments will be explained. The components having the same reference numbers are expected to operate similarly as in Embodiments 1 and 2.

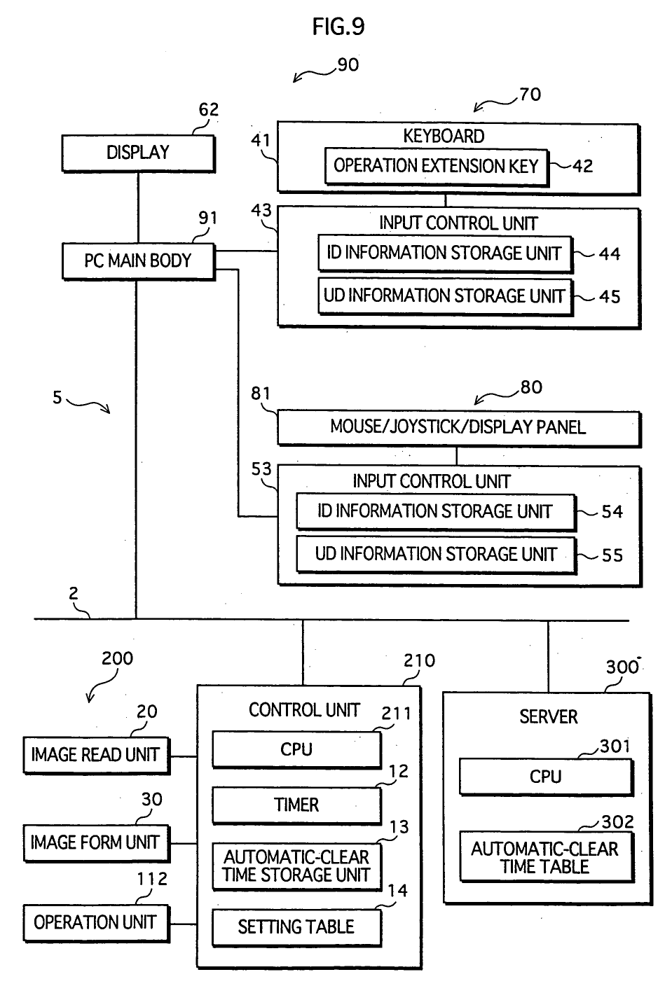

FIG. 9 is a block diagram showing the construction of an input processing system 5 in Embodiment 3.

As shown in FIG. 9, the input processing system 5 includes a terminal apparatus 90, a copying machine 200, and a server 300 that are connected to each other via the LAN 2.

The construction of the terminal apparatus 90 is basically the same as that of the terminal apparatus 60 in Embodiment 2 except that a PC main body 91 transmits an input signal and ID to the server 300.

The server 300 includes a CPU 301 and an automatic-clear time table 302. On receiving a remote operation start signal from the terminal apparatus 90, the server 300 transfers the remote operation start signal to the copying machine 200 to place the copying machine 200 in the remote operation mode. Also, upon receiving an input signal and ID from the terminal apparatus 90, the server 300 transfers them to the copying machine 200.

The CPU 301 executes the automatic-clear time determination process in which it determines the automatic-clear time by identifying the input unit, judging whether the input unit is universal-design-compliant, and judging whether an operation extension has been specified. The CPU 301 then transmits data of the determined automatic-clear time to the copying machine 200. As apparent from this, in the present embodiment, the copying machine does not determine the automatic-clear time.

The automatic-clear time table 302 has the same construction as the automatic-clear time table 15.

The copying machine 200 basically has the same construction as the copying machine 100 in Embodiment 2, except for the construction of a control unit 210.

The control unit 210 includes a CPU 211, the timer 12, automatic-clear time storage unit 13, and setting table 14.

Upon receiving a remote operation start signal from the server 300, the CPU 211 goes into the remote operation mode, and executes the input signal reception process as will be described later. The timer 12, automatic-clear time storage unit 13, and setting table 14 have the same construction as those in Embodiments 1 and 2. It should be noted here that the control unit 210 does not include an automatic-clear time table since the automatic-clear time determination process is performed by the server.

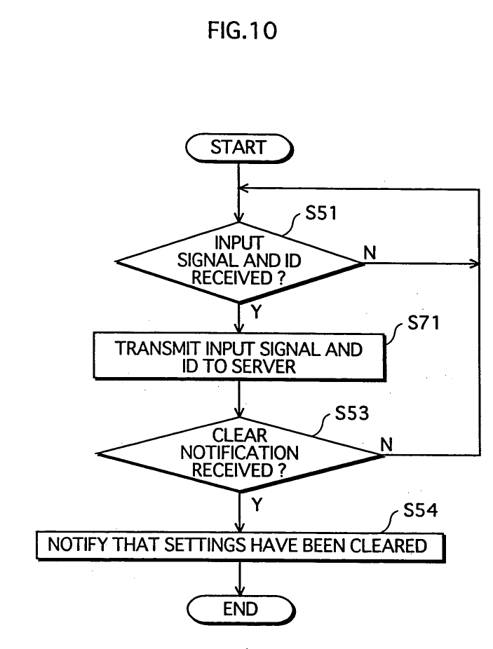

FIG. 10 is a flowchart of an input signal reception/transmission process executed by the PC main body 91 of the terminal apparatus 90. The input signal reception/transmission process is executed only in the remoter operation mode.

As shown in FIG. 10, the procedures of the process in Embodiment 3 are basically the same as those shown in FIG. 7 in Embodiment 2 except that step S52 is replaced with step S71 in which the input signal and ID are transmitted to the server 300.

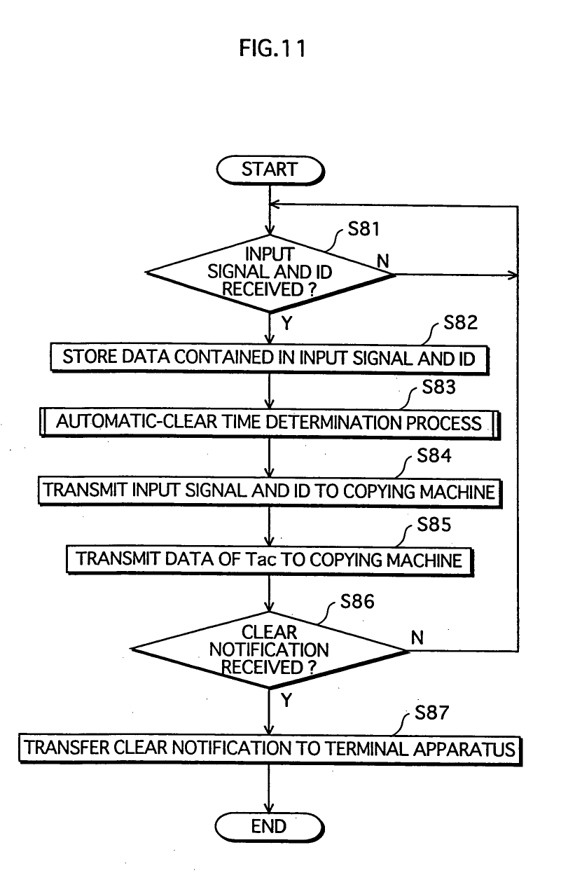

FIG. 11 is a flowchart of a process executed by the CPU 301 of the server 300.

As shown in FIG. 11, when it is judged that an input signal and ID have been received from the terminal apparatus (“Y” in step S81), the CPU 301 temporarily stores the data contained in the received input signal and ID into an internal memory (not illustrated) (step S82). The CPU 301 then executes the automatic-clear time determination process (step S83). The automatic-clear time determination process executed here is the same as that executed in Embodiment 1 (FIG. 5). The CPU 301 then reads the temporarily stored data from the internal memory and transmits it to the copying machine 200 (step S84), then transmits the data of the automatic-clear time “Tac” determined in the automatic-clear time determination process to the copying machine 200 (step S85).

The CPU 301 then judges whether a clear notification (the same as that in Embodiment 2) has been received (step S86). If the judgment result in step S86 is negative (“N”), the control returns to step S81 in which the CPU 301 waits for another input signal and ID to be received.

If the judgment result in step S86 is positive (“Y”), the CPU 301 transfers the received clear notification to the terminal apparatus 90 (step S87), and ands the process.

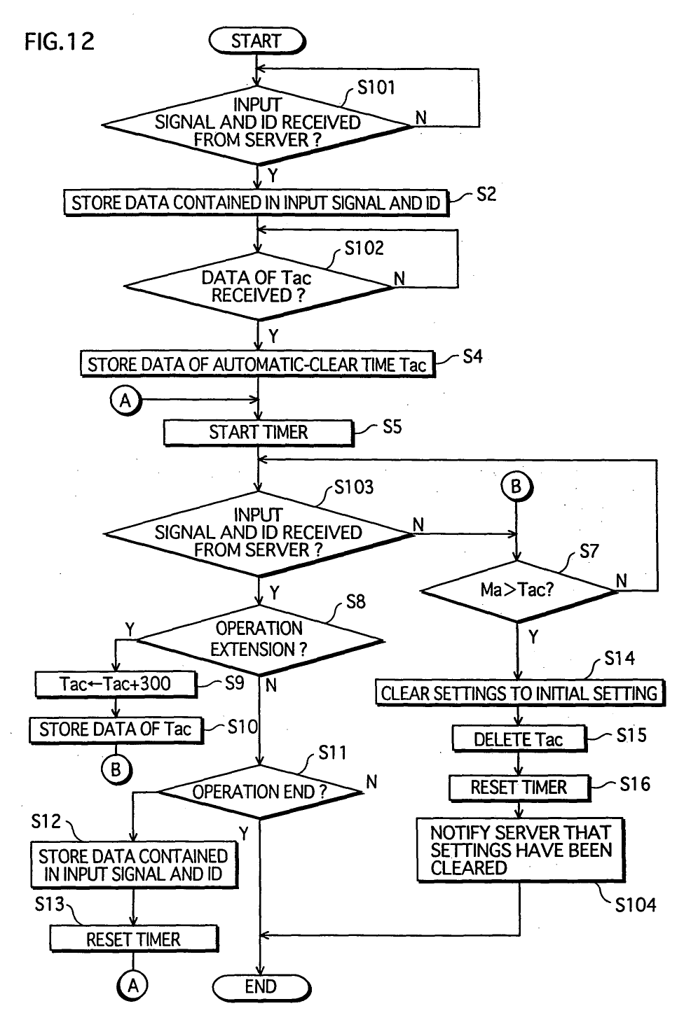

FIG. 12 is a flowchart of the input signal reception process executed by the CPU 211 of the copying machine 200. The input signal reception process is executed only in the remote operation mode. The process is almost the same as the one in Embodiment 1 (FIG. 4) except for steps S101, S102, S103, and S104.

Step S101 corresponds to step S1. In step. S101, it is judged whether an input signal and ID have been received from the server 300.

If the CPU 211 judges positively in step S101 (“Y”), the CPU 211 rewrites the data contained in the input signal and ID onto the corresponding columns in the setting table 14 (step S2). The CPU 211 then judges whether the data of the automatic-clear time “Tac” has been received from the server 300 (step S102). If the CPU 211 judges positively in step S102 (“Y”), the CPU 211 stores the data of the automatic-clear time “Tac” into the automatic-clear time storage unit 13 (step S4).

The CPU 211 then causes the timer to start clocking (step S5), and judges whether another input signal and ID have been received (step S103). If the CPU 211 judges positively in step S103 (“Y”), the CPU 211 moves to step S8. If the CPU 211 judges negatively in step S103 (“N”), the CPU 211 moves to step S7. Steps S7-S16 in this process in Embodiment 3 are the same as those in Embodiment 1. The CPU 211 then activates the automatic clear function and clears the settings, and ends the process after transmitting a clear notification to the server 300 in step S104, where the clear notification notifies that the settings have been cleared.

As described above, the server 300 transfers the received clear notification to the terminal apparatus 90 in step S87. Upon receiving the clear notification, the terminal apparatus 90, for example, displays a message on the display 62 to notify the user of the fact that the settings have been cleared.

As described above, the automatic-clear time determination process is performed by the server 300, not by the copying machine. This takes as much load off the CPU of the copying machine. Also, this eliminates the copying machine having to store the automatic-clear time table, and reduces the memory capacity as much.

Modifications

Up to now, some of the preferred embodiments of the present invention have been explained. However, not limited to the embodiments, the present invention can be modified in various ways, including the following examples.

(1) In Embodiments 1-3, two input units (input apparatuses) are provided. However, not limited to two input units, three or more input units may be provided. For example, in addition to the keyboard and the joystick/mouse in the embodiments, a touch panel, an audio switch, a mouthpiece switch, and a sight line switch may be provided. Here, the audio switch enables the user to input specification of the number of sheets to be copied or the like by means of a voice/sound emitted by the user. The mouthpiece switch enables the user to input such a specification by biting or pushing a tongue onto a mouthpiece. The sight line switch enables the user to input such a specification by blinking or gazing at an object for a certain time period.

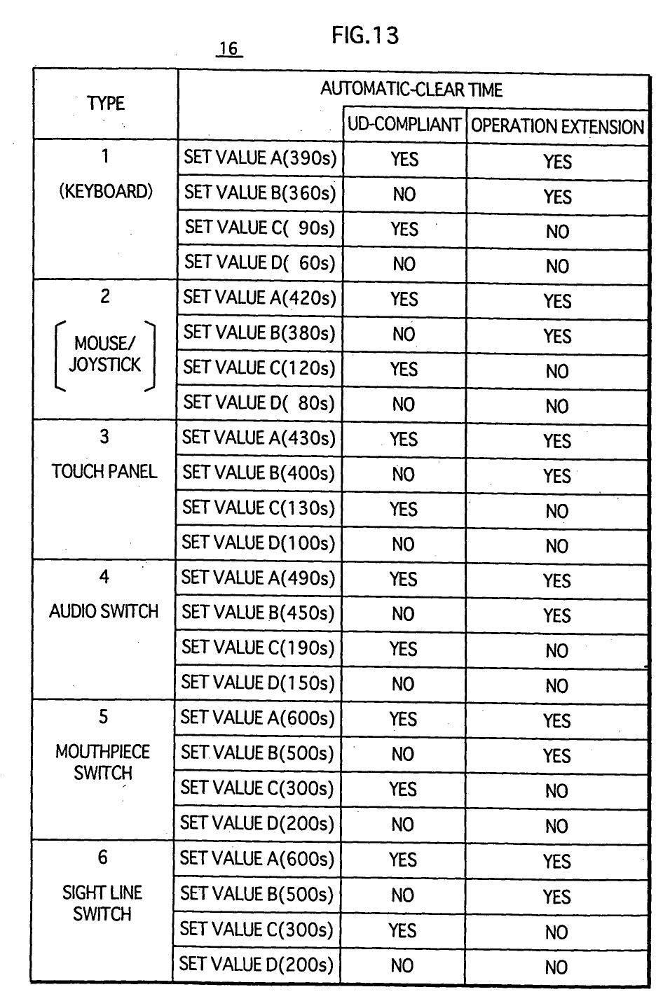

When these input units are provided, an automatic-clear time table such as an automatic-clear time table 16 shown in FIG. 13 may be prepared so that the automatic-clear time can be set to any of the set values A-D in accordance with which of the input units has been used, whether the input unit is universal-design-compliant, and whether an operation extension has been specified. In the automatic-clear time table 16, longer automatic-clear times are assigned to the input units which are expected to require longer operation times. Also, a plurality of input units different from the above-mentioned ones may be provided in so far as the automatic-clear time is determined in accordance with which of the plurality of input units is used.

(2) In Embodiments 2 and 3, a plurality of input apparatuses are connected to one terminal apparatus. Not limited to this, the present invention can be applied to other systems having different configurations. For example, the present invention may be applied to an input processing system that includes a plurality of terminal apparatuses and one copying machine that are connected to each other via a network, where a plurality of input units are further connected to the plurality of terminal apparatuses on a one-to-one basis so that a remote operation can be performed at each terminal apparatus. In such an input processing system, the terminal apparatuses may be assigned to the users on a one-to-one basis. In that case, it is expected that most of the users will use a type of input apparatus that is most convenient for them. Especially, this will be the case with the disabled. Taking this into consideration, information indicating the type of the input apparatus may be transmitted from a terminal apparatus to the copying machine during the remote operation so that the copying machine can determine the automatic-clear time in accordance with the type of the input apparatus. This provides the effect that the automatic-clear time is set appropriately for both the disabled and the able-bodied.

(3) In the above-described embodiments, the automatic-clear time is increased by five minutes each time the operation extension key (button) is depressed before or during an input operation by the user. However, the automatic-clear time may be increased by five minutes only once when the operation extension key (button) is depressed before or during an input operation by the user. That is to say, the operation extension is allowed only once. Furthermore, the operation extension may be allowed only before an input operation, or only during an input operation.

(4) In the above-described embodiments, predetermined automatic-clear times for each input unit are written in advance in the automatic-clear time table 15 or 16. However, the user may change the automatic-clear time to a desired value through the operation unit or the like. Similarly, the user may change the operation extension time (five minutes) per key (button) depression to a desired value.

(5) In Embodiment 1, the input control units 43 and 53 transmit an input signal and ID information to the overall control unit 10. That is to say, the input signal and ID information are transmitted separately. However, a set of data that includes the input signal and ID information may be transmitted each time an input operation is performed. This applies also to Embodiments 2 and 3.

(6) In Embodiment 1, the present invention is applied to a copying machine. However, the present invention can be applied to any device that has the automatic-clear function, such as an image processing apparatus like a scanner, a printer, and a facsimile. Also, in Embodiments 2 and 3, a copying machine is operated by a remote operation. However, the device that is operated by a remote operation may be any device in so far as it has the automatic-clear function, such as an image processing apparatus like a scanner, a printer, and a facsimile. Also, a copying machine may contain a separate device that executes a process for the automatic-clear function.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An input processing system comprising:
a plurality of input apparatuses;
a processing apparatus;
a setter that sets an operation of the processing apparatus in accordance with an input entered through an input operation performed on an input apparatus among the plurality of input apparatuses; and
a controller that determines an automatic-clear time for the input apparatus on which the input operation was performed, wherein a different automatic-clear time is determined for each of the plurality of input apparatuses, and if another input operation is not performed on the input apparatus during the determined automatic-clear time, executes an automatic-clear function to clear the set operation to an initially set default.

2. The input processing system of claim 1 further comprising
a receiver that receives an extension request entered by a user to extend the determined automatic-clear time, wherein
the controller extends the determined automatic-clear time after the receiver receives the extension request.

3. The input processing system of claim 1 further comprising
an identifying unit that identifies the input apparatus on which the input operation was performed, wherein
the controller identifies the input apparatus from a result of the identification by the identifying unit.

4. The input processing system of claim 3, wherein
the input apparatus transmits, to the identifying unit, identification information that identifies the input apparatus on which the input operation was performed, and
the identifying unit identifies the input apparatus based on the identification information transmitted from the input apparatus.

5. The input processing system of claim 1 further comprising
a table storing data of automatic-clear times respectively corresponding to the plurality of input apparatuses, wherein
the controller reads data of an automatic-clear time corresponding to the input apparatus on which the input operation was performed, and determines the automatic-clear time of the read data as the automatic-clear time for the input apparatus.

6. The input processing system of claim 5, wherein
the data stored in the table can be rewritten.

7. The input processing system of claim 1, wherein the controller determines a longer automatic-clear time for an input apparatus that is universal-design-compliant than for an input apparatus that is not universal-design-compliant.

8. The input processing system of claim 1, wherein
the controller determines an automatic-clear time for an object input apparatus in a manner where the longer an interval between input operations in the object input apparatus is expected to be, the longer the automatic-clear time determined for the object input apparatus is.

9. An image processing apparatus that receives inputs through a plurality of input apparatuses, comprising:
a setter that sets an operation of the processing apparatus in accordance with an input entered through an input operation performed on an input apparatus among the plurality of input apparatuses; and
a controller that determines an automatic-clear time for the input apparatus on which the input operation was performed, wherein a different automatic-clear time is determined for each of the plurality of input apparatuses, and if another input operation is not performed on the input apparatus during the determined automatic-clear time, executes an automatic-clear function to clear the set operation to an initially set default.

10. The image processing apparatus of claim 9 further comprising
a receiver that receives an extension request entered by a user to extend the determined automatic-clear time, wherein
the controller extends the determined automatic-clear time after the receiver receives the extension request.

11. The image processing apparatus of claim 9 further comprising
an identifying unit that identifies the input apparatus on which the input operation was performed, wherein
the controller identifies the input apparatus from a result of the identification by the identifying unit.

12. The image processing apparatus of claim 11, wherein
the input apparatus transmits, to the identifying unit, identification information that identifies the input apparatus on which the input operation was performed, and
the identifying unit identifies the input apparatus based on the identification information transmitted from the input apparatus.

13. The image processing apparatus of claim 9 further comprising
a table storing data of automatic-clear times respectively corresponding to the plurality of input apparatuses, wherein
the controller reads data of an automatic-clear time corresponding to the input apparatus on which the input operation was performed, and determines the automatic-clear time of the read data as the automatic-clear time for the input apparatus.

14. The image processing apparatus of claim 13, wherein
the data stored in the table can be rewritten.

15. The image processing apparatus of claim 9, wherein
the controller determines a longer automatic-clear time for an input apparatus that is universal-design-compliant than for an input apparatus that is not universal-design-compliant.

16. The image processing apparatus of claim 9, wherein
the controller determines an automatic-clear time for an object input apparatus in a manner where the longer an interval between input operations in the object input apparatus is expected to be, the longer the automatic-clear time determined for the object input apparatus is.

17. The image processing apparatus of claim 9, wherein
at least one of the plurality of input apparatuses is connected to the image processing apparatus via a network.

18. The image processing apparatus of claim 9, wherein
at least one of the plurality of input apparatuses is connected to a terminal apparatus that is connected to the image processing apparatus via a network.

19. The image processing apparatus of claim 18, wherein
after executing the automatic-clear function, the controller notifies the terminal apparatus of a fact that the controller has executed the automatic-clear function.

20. The image processing apparatus of claim 9, wherein
one or more of the plurality of input apparatuses are connected to the image processing apparatus via a server provided in a network.

21. The image processing apparatus of claim 20, wherein
the server includes a table storing data of automatic-clear times respectively corresponding to the one or more input apparatuses connected to the image processing apparatus via the server, wherein
if the input apparatus on which the input operation was performed is one of the one or more input apparatuses connected to the image processing apparatus via the server, the controller obtains, from the server, data of an automatic-clear time corresponding to the input apparatus, and determines the automatic-clear time of the obtained data as the automatic-clear time for the input apparatus.

22. The image processing apparatus of claim 20, wherein
after executing the automatic-clear function, the controller notifies the server of a fact that the controller has executed the automatic-clear function.
